(19) United States
(12) Patent Application Publication
(10) Pub. No.: US 2019/0388913 A1
(43) Pub. Date: Dec. 26, 2019

(54) Hydraulic Flow Control System, Primary Valve for Hydraulic Flow Control System and Hygienic Shower Head for Hydraulic Flow Control System

(71) Applicant: DURATEX S.A., Sao Paulo (BR)

(72) Inventors: Regis DE CARVALHO ROMERA, Sao Paulo (BR); Vinicius GONZALEZ, Santo Andre (BR)

(21) Appl. No.: 16/480,496

(22) PCT Filed: Feb. 9, 2018
(86) PCT No.: PCT/BR2018/050026

§ 371 Date: Jul. 24, 2019

(30) Foreign Application Priority Data
Feb. 10, 2017 (BR) 1020170027392

(51) Int. Cl. B05B 1/30; B05B 1/18; B05B 12/00

(52) U.S. Cl. CPC B05B 1/3013; F16K 1/20; B05B 12/002; B05B 1/18

(57) ABSTRACT

The present invention relates to the technological field of hydraulic flow control systems in hydraulic circuits provided with control valves. Problem to be solved: Nowadays, the hygienic shower heads are currently subject to high hydraulic pressure, which is usually sufficient to cause their breakage. Problem solution: A hydraulic flow control system is proposed between a primary valve and a hygienic shower head, wherein these two components are fluidly connected by a dual pipe, wherein the pressure of the hydraulic network is confined in the internal pipe, thus reducing the rupture of the external piping.

### FIELD OF THE INVENTION

The present invention relates to a hydraulic flow control system and, more particularly, a hydraulic flow control system for hygienic shower heads and/or congener equipment.

In general terms, the hydraulic flow control system stands out by enabling the activation/deactivation of a primary valve arranged downstream of the water supply pipe by means of the operation of a secondary valve arranged in the hygienic shower head itself and/or congener equipment.

### BACKGROUND OF THE INVENTION

As discussed in detail in the patent document PI 11008768, there is a strong tendency of replacing bidets by hygienic shower heads attachable to toilets. Such a trend is justified by the fact that such an alternative solution—hygienic shower heads attachable to toilets—is significantly more economical and requires significantly less space for installation and usability.

As known to those skilled in the art, the known hygienic shower heads are essentially composed of a diffuser head provided with a valve manually controlled by a trigger, the diffuser head being hydraulically fed from a point of attachment to the supply hydraulic network usually by means of a manually operated valve and a flexible conduit which may have different constructions. Generally, the triggering actuator of the valve of the diffuser head is provided with a latch, so that the valve can be maintained in an open condition without the user remaining pressing the trigger. In addition, as explained in the patent document PI 11008768, it is common for the manually operated valve to be provided with a tap, generally in “T” form, for connection of a rigid or flexible supply piping from another point of consumption in the bathroom, point which is often defined by a drainage box coupled to the toilet.

Considering this type of totally conventional installation, it is verified that the manual operation valve only controls the opening and/or closing of the diffuser head supply and, therefore, it is recommended for users, especially in high pressure installations, that said manual operating valve is always closed after use of the shower, and, even more preferably, prior to the release of the trigger. The general idea is to avoid critical pressure situations where possible water hammer strikes in the hydraulic network can break the flexible conduit and allow pressurized water to leak into the bathroom. It happens that, users invariably fail to close the manual operation valve upon completion of the shower operation, keeping the flexible conduit continuously pressurized by the pressure of the available hydraulic network in the bathroom.

In order to remedy such a hazardous situation, the patent document PI 11008768 itself describes a valve with manual opening and automatic, timed hydraulic closure, which, regardless of the user's wishes, assumes a closing state after the use of the hygienic shower head. Although functional, the timed automatic closing characteristic may represent a usability problem, after all, the closure time does not always match the expectations of the user in a scenario of purposely disruptive use of the hygienic shower head.

It is therefore based on this scenario that the invention in question arises.

### OBJECTIVES OF THE INVENTION

Thus, it is the fundamental objective of the invention in question to disclose a hydraulic flow control system whose actuation/disengagement of a primary valve (functionally analogous to the manual operation valve of the state of the art) is performed remotely by a secondary valve (functionally analogous to the trigger valve of a hygienic shower head of the current state of the art).

Thus, it is an object of the invention that both the disengagement and the actuation of said primary valve take place organically, without the direct interference of the user.

In this regard, it is also an object of the present invention that the flexible pipe interconnecting the primary and secondary valves does not become pressurized in the event of non-use of the hygienic shower head.

Moreover, it is also the object of the present invention to disclose the constructive details of both the primary valve and the secondary valve that integrates the hygienic shower head.

### SUMMARY OF THE INVENTION

The objectives summarized above are fully achieved by means of the hydraulic flow control system, which comprises at least one primary valve (provided with at least one fluid inlet path, at least one fluid outlet path, and at least one seat-shutter assembly arranged between the at least one fluid inlet path and the at least one fluid outlet path) and at least one hydraulic fluid spray device (provided with at least one fluid inlet path, at least one fluid outlet path, at least one seat-shutter assembly arranged between the at least one fluid inlet path and the at least one fluid outlet path, and at least one operating means), wherein the fluid outlet path of the primary valve and the fluid inlet path of the hydraulic fluid spray device are fluidly connected by means of at least one dual pipe formed by an external pipe and an internal pipe.

Changing the operational state of the seat-shutter assembly of the hydraulic fluid spray device is performed directly by means of handling the operating means of the hydraulic fluid spray device, and the alteration of the operating state of the seat-shutter assembly of the primary valve is performed indirectly by means of the handling of the operating means of the hydraulic fluid spray device.

According to the invention in question, the seat-shutter assembly of the primary valve is responsive to the pressure differential existing between the hydraulic pressure of the fluid inlet path of the primary valve and the internal pipe pressure of the dual pipe, which fluidly connects the fluid outlet path of the primary valve and the fluid inlet path of the hydraulic fluid spray device. More particularly, the seat-shutter assembly of the primary valve assumes an “opened position” from the lowering of the internal pipe pressure of the dual pipe that fluidly connects the fluid outlet path of the primary valve and the fluid inlet path of the hydraulic fluid spray device, wherein the pressure of the internal pipe of the dual pipe, which fluidly connects the fluid outlet path of the primary valve and the fluid inlet path of the hydraulic fluid spray device is decreased as a function of the “opened position” assumed by the seat-shutter assembly of the hydraulic fluid spray device. The seat-shutter assembly of the hydraulic fluid spray device assumes an “opened position” from the handling of the operating means.

The aforementioned objects are also achieved by the primary valve for a hydraulic flow control system, which comprises at least one fluid inlet path, at least one fluid outlet path and at least one seat-shutter assembly arranged between the at least one fluid inlet path and the at least one fluid outlet path, wherein the shutter of the seat-shutter assembly comprises a flexible membrane and the seat of the seat-shutter assembly comprises a rigid tubular body.

According to the invention in question, the fluid outlet path of the primary valve for hydraulic flow control system is especially adapted to receive a dual pipe formed by an external pipe and an internal pipe, wherein the external pipe of the dual pipe is connected to the seat of the seat-shutter assembly and the internal pipe of the dual pipe is associated to the shutter of the seat-shutter assembly.

Preferably, in a “closed position”, two pressurized chambers are defined, wherein the pressurized chamber is equalized to the hydraulic pressure of the fluid inlet path and the other pressurized chamber is equalized to the hydraulic pressure of the internal pipe of the dual pipe. In this sense, the inside of the external pipe of the dual pipe is isolated from the pressurized chambers.

Preferably, in an “opened position”, a single pressurized chamber is defined, wherein the external pipe and the internal pipe of the dual pipe are equalized to the hydraulic pressure of the pressurized chamber.

In addition, the above objects are further achieved by the hygienic shower head for a hydraulic flow control system, which comprises at least one fluid inlet path, at least one fluid outlet path, at least one seat-shutter assembly arranged between the at least one fluid inlet path and the at least one fluid outlet path, and at least one operating means.

According to the invention in question, the fluid inlet path from the hygienic shower head for the hydraulic flow control system is especially adapted to receive a dual pipe formed by an external pipe and an internal pipe, wherein the external pipe of the dual pipe is connected to the seat of the seat-shutter assembly and the internal pipe of the dual pipe is associated to the shutter of the seat-shutter assembly.

Preferably, the operating means is externally arranged and comprises a handle capable of angular movement cooperating with a pivot axis arranged within the body of said hygienic shower head.

Generally, the shutter of the seat-shutter assembly is physically cooperating with a pivot axis arranged within the body of said hygienic shower head and the angular movement of the operating means alters the axial alignment between the seat and the shutter of the seat-shutter assembly.

### BRIEF DESCRIPTION OF THE DRAWINGS

The invention in question will be meticulously detailed on the basis of the following illustrative figures, which:

FIGS. 1 and 2 show, in schematic cross-section, the primary valve according to the invention in question, in a closed position and an opened position, respectively; and

FIGS. 3 and 4 illustrate, in schematic cross-section, the hygienic shower head according to the invention in question, in a closed position and an open position, respectively.

### DETAILED DESCRIPTION OF THE INVENTION

It is first of all important to emphasize that the main purpose of the invention is to ensure the correct operational state of a “primary valve” as a function of the operation of a “secondary valve” in a hydraulic flow control system especially suited to hygienic shower heads whose hydraulic supply comes from the water supply network.

In this regard, according to the invention in question, the expression “primary valve” refers to the valve, which releases and/or blocks the hydraulic flow of the water supply network.

In this same sense, according to the invention in question, the term “secondary valve” refers to the valve arranged within the hygienic shower head itself.

Consequently, considering a preferred hydraulic circuit (not shown), the “primary valve” and the “secondary valve” can be considered to be arranged in series, so that a hydraulic flow from the water supply network (water flow) only reaches the outlet path of the hygienic shower head if these two valves are open.

More particularly, the central objects of the invention may be summarized as follows:
Disclosing a hydraulic flow control system through which the flexible pipe defining the fluid communication between the “primary valve” and the “secondary valve” is not unduly pressurized; and
Disclosing a hydraulic flow control system through which the operation of the “primary valve” is responsive to the operation of the “secondary valve”.

To this end, the hydraulic flow control system disclosed herein is essentially composed of two components, namely: a primary valve 1 (valve arranged downstream of the water supply network) and a hydraulic fluid spray device 4 (hygienic shower head).

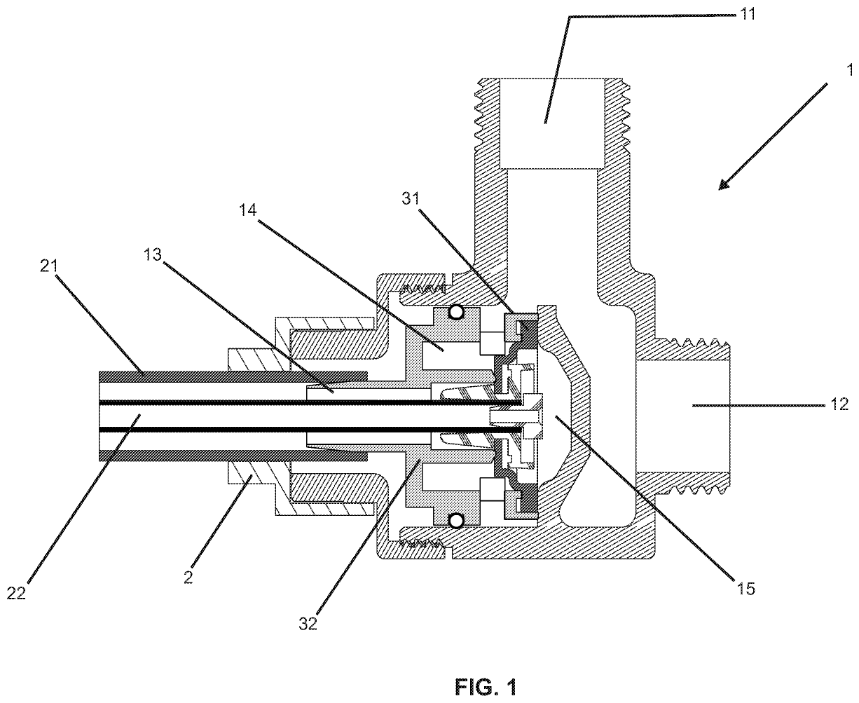

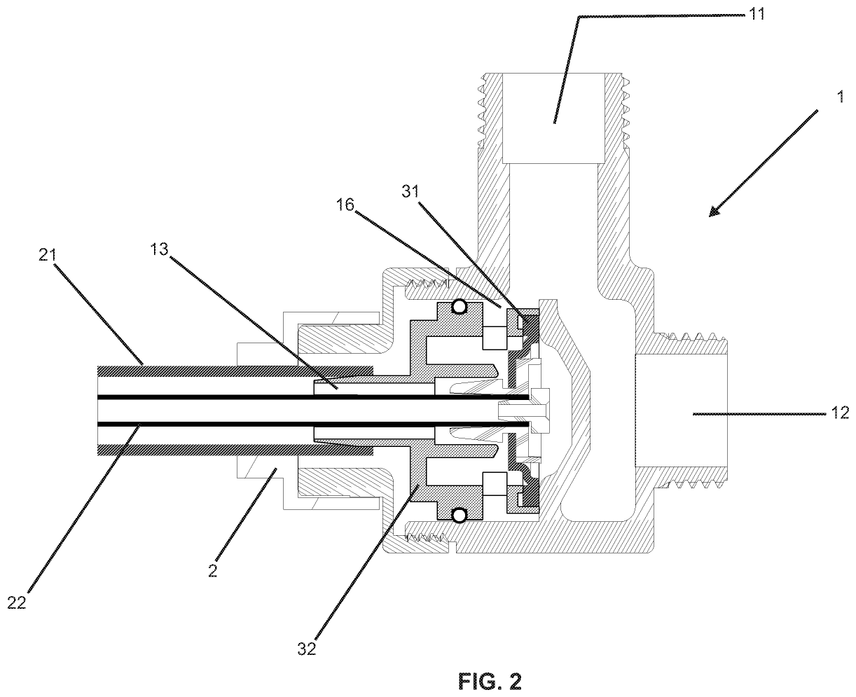

Said primary valve 1 is schematically shown in FIGS. 1 and 2, wherein in said FIG. 1, the primary valve 1 is in the “closed position” and in FIG. 2 the primary valve 1 is in the “opened position”.

In its preferred embodiment, as shown in FIGS. 1 and 2, the primary valve 1 comprises a monoblock metal body defining a fluid inlet path 11, a first fluid outlet path 12, and a fluid outlet path 13. The fluid outlet paths 12 and 13 are perpendicular to the fluid inlet path 11.

Said primary valve 1 further comprises a seat-shutter assembly 32, 31 arranged between the fluid inlet path 11 and the fluid outlet path 13. It is noted, therefore, that fluid communication between the fluid inlet path 11 and the fluid outlet path 13 can be controlled by means of the seat-shutter assembly 32, 31. On the other hand, the fluid communication between the fluid inlet path 11 and the fluid outlet path 12 is, according to this preferred embodiment, free.

More particularly, always considering the preferred embodiment illustrated in FIGS. 1 and 2, the shutter 31 of the seat-shutter assembly 32, 31 comprises a flexible membrane and the seat 32 of the seat-shutter assembly 32, 31 comprising a rigid tubular body, wherein such types of component can be considered as commonly used.

In any case, the primary valve 1 is distinguished by the fact that its fluid outlet path 13, preferably provided with a finishing body 2, is specially adapted to receive a dual pipe formed by an external pipe 21 and an internal pipe 22, whereby the external pipe 21 of the dual pipe is connected to the seat 32 of the seat-shutter assembly 32, 31 and the internal pipe 22 of the dual pipe is associated to the shutter 31 of the seat-shutter assembly 32, 31.

As previously discussed, the fluid communication between the fluid inlet path 11 and the fluid outlet path 13 can be controlled by means of the seat-shutter assembly 32, 31. Consequently, as far as this communication is concerned, the primary valve 1, by means of the seat-shutter assembly 32, 31, may assume a “closed position” or an “opened position”.

In the “closed position” there is no fluid communication between the fluid inlet path 11 and the fluid outlet path 13 and, consequently, the external pipe 21 has no contact with fluid from the fluid inlet path 11.

Preferably, there are small holes (not shown) in the shutter 31, which communicate the fluid inlet 11 with the chamber 15. The communication between the chamber 15 and the internal pipe 22 is constant. Therefore, they are subject to hydraulic pressure when the shower head is not in operation: the inlet 11, the chamber 15, the internal pipe 22 and the seat/shutter assembly 5, 7.

In the “opened position” there is fluid communication between the fluid inlet path 11 and the fluid outlet path 13 and, consequently, both the external pipe 21 and the internal pipe 22 of the dual pipe (attached to the fluid outlet path 13) enter into contact with the fluid from the fluid inlet path 11.

Considering that said primary valve 1 comprises a seat-shutter assembly 32, 31 in which the shutter 31 comprises a flexible membrane, it is noteworthy that the movement of said membrane occurs by pressure differential, as known to those skilled in the art.

Thus, when closed, the primary valve 1 has defined therein two pressurized chambers 14, 15 insulated from each other, wherein the pressurized chamber 14 is equalized to the hydraulic pressure of the fluid inlet path 11 and the pressurized chamber 15 is equalized to the hydraulic pressure of the internal pipe 22 of the dual pipe. Consequently, the interior of the external pipe 21 of the dual pipe is isolated from the pressurized chambers 14, 15.

On the other hand, when opened, the primary valve 1 has defined therein a single pressurized chamber 16, wherein the external pipe 21 and the internal pipe 22 of the dual pipe are equalized to the hydraulic pressure of the pressurized chamber 16, which is supplied by the fluid inlet path 11.

In general terms, the primary valve 1 stands out in that it can receive, in its fluid outlet path 13, a dual pipe whose functionality will be detailed below.

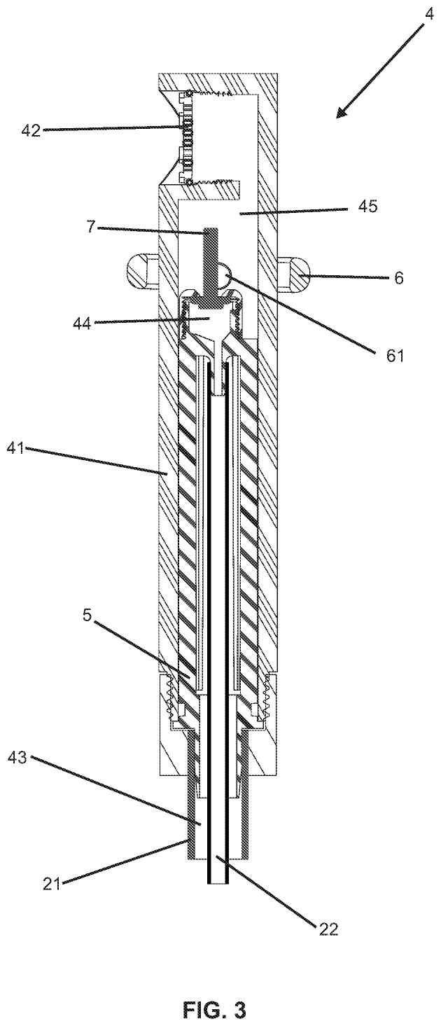

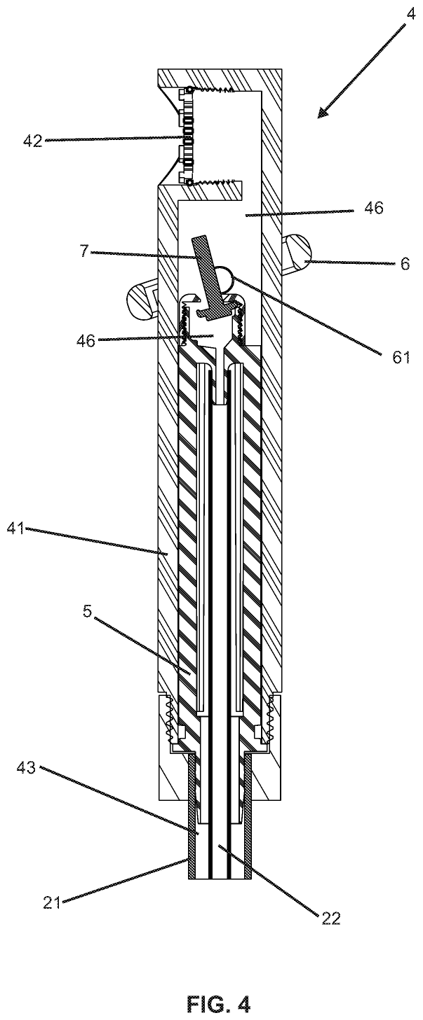

The hydraulic flow control system is also encompassed by a hydraulic fluid spray device 4, which is refers, as shown in FIGS. 3 and 4, to a hygienic shower head.

In its preferred embodiment, as shown in FIGS. 3 and 4, the hygienic shower head comprises a preferably monoblock body 41 in which it is defined a fluid inlet path 43 and a fluid outlet path 42.

The hygienic shower head comprises, within its monoblock body 41, a seat-shutter assembly 5, 7 arranged between the fluid inlet path 43 and the fluid outlet path 42.

In addition, the hygienic shower head comprises, on the outside of its monoblock body 41, an operating means 6 by means of which it is possible to change the positioning of the elements that integrate the seat-shutter assembly 5, 7.

In general terms, the hygienic shower head (or hydraulic fluid spray device 4) is distinguished by the fact that its fluid inlet path 43 is specially adapted to receive a dual pipe formed by an external pipe 21 and an internal pipe 22, wherein, in particular, the external pipe 21 of the dual pipe is connected to the seat 5 of the seat-shutter assembly 5, 7, and the internal pipe 22 of the dual pipe is associated to the shutter 7 of the seat-shutter assembly 5, 7.

According to the invention in question, the operating means 6 comprises a handle which, arranged on the outside of the monoblock body 41, is able to move angularly, wherein it further cooperates with a pivot axis 61 which, arranged inside the body 41, is physically cooperative with a pivot axis 61 arranged within the body 41 of said hygienic shower head 4.

As shown schematically in FIGS. 3 and 4, it is observed that the angular movement of the operating means 6, by changing the positioning of the pivot axis 61, changes the axial alignment between the seat 5 and the shutter 7 of the seat-shutter assembly 5, 7.

As well as it occurs with the primary valve 1, the hygienic shower head (or hydraulic fluid spray device 4), the fluid communication between the fluid inlet path 43 and the fluid outlet path 42 may also be controlled by means of the seat-shutter assembly 5, 7. Consequently, with respect to this communication, the hygienic shower head, by means of the seat-shutter assembly 5, 7 may assume a “closed position” or an “opened position”.

In the “closed position” there is no fluid communication between the fluid inlet path 43 and the fluid outlet path 42 and, consequently, both the external pipe 21 and the internal pipe 22 of the dual tube (attached to the outlet fluid path 43) are not able to conduct fluid into the fluid outlet path 42.

In the “opened position” there is fluid communication between the fluid inlet path 43 and the fluid outlet path 42 and, consequently, both the external pipe 21 and the internal pipe 22 of the dual tube (attached to the fluid outlet path 43) are capable of conducting fluid to the fluid outlet path 42.

Considering that said hygienic shower head comprises a seat-shutter assembly 32, 31 in which the shutter 7 comprises a sealing rod, it is noteworthy that the movement thereof occurs by means of cooperation with the operating means 6. Accordingly, the change from the “closed position” to the “opened position” or from the “opened position” to the “closed position” occurs manually by means of the operation, usually by a user, of the operating means 6.

When closed, the hygienic shower head has two chambers 44, 45 isolated from each other, defined therein, wherein the chamber 44 is equalized to the hydraulic pressure of the internal pipe 22 of the dual pipe, and the chamber 45 is equalized with the fluid outlet path 42. Consequently, the interior of the external pipe 21 of the dual tube is isolated from the chamber 44.

When opened, the hygienic shower head has defined in it, a single pressurized chamber 46 defined therein, wherein the external pipe 21 and the internal pipe 22 of the dual tube are equalized to the hydraulic pressure of the pressurized chamber 16, which is supplied by the fluid inlet path 43.

In general terms, the hygienic shower head (or hydraulic fluid spray device 4) stands out by the fact that it can receive, in its fluid inlet path 43, a dual pipe whose functionality will be hereinafter detailed.

As previously mentioned, both the primary valve 1 and the hygienic shower head (or hydraulic fluid spray device 4) stand out in that they can receive an dual pipe encompassed by an external pipe 21 and the internal pipe 22, these are preferably concentric and made of material flexible. Thus, the fluid outlet path 13 of the primary valve 1 and the fluid inlet path 43 of the hydraulic fluid spray device 4 may be fluidly connected by means of the dual pipe formed by an external pipe 21 and an internal pipe 22.

This means that once connected by said dual pipe, two fluid communication means are defined between the primary valve 1 and the hygienic shower head (or hydraulic fluid spray device 4).

The internal pipe 22, arranged between the interior of the seats 32 and 5 and acting directly on the shutters 31 and 7, acts as a kind of control extension pipe, that is, it is through the internal pipe 22 that the command imposed on the shutter 7 by means of the actuation means 6 is transmitted to the shutter 31. Consequently, the change in the operational state of the seat-shutter assembly 5, 7 of the hydraulic fluid spray device 4 is carried out directly by means of the handling of the operating means 6 of the hydraulic fluid spray device 4 and the changing of the operating state of the seat-shutter assembly 32, 31 of the primary valve 1 is performed indirectly by means of the handling of the operating means 6 of the hydraulic fluid spray device 4.

This (the fact that the changing of the operating state of the seat-shutter assembly 32, 31 of the primary valve 1 is carried out indirectly by means of the handling of the operating means 6 of the hydraulic fluid spray device 4) occurs by the fact that the shutter 31 (membrane type) is susceptible to deformations as a function of the external pressure. Therefore, by reducing the pressure of the internal pipe 22 of the dual pipe by changing the operating state of the seat-shutter assembly 5, 7 of the hydraulic fluid spray device 4, the shutter 31 (membrane type) is deformed so as to change the operating state of the seat-shutter assembly 32, 31 of the primary valve 1.

Consequently, it can be said that the seat-shutter assembly 32, 31 of the primary valve 1 is sensitive to the existing pressure differential between the hydraulic pressure of the fluid inlet path 11 of the primary valve 1 and the pressure of the internal pipe 22 of the dual pipe, which fluidly connects the fluid outlet path 13 of the primary valve 1 and the fluid inlet path 43 of the hydraulic fluid spray device 4.

Thus, it is noted that the seat-shutter assembly 32, 31 of the primary valve 1 assumes an “opened position” from the decrease of the pressure of the internal pipe 22 of the dual pipe, which fluidly connects the fluid outlet path 13 of the primary valve 1 and the fluid inlet path 43 of the hydraulic fluid spray device 4, after all, the pressure of the internal pipe 22 of the dual tube that fluidly connects the fluid outlet path 13 of the primary valve 1 and the fluid inlet path 43 of the hydraulic fluid spray device 4 is decreased as a function of the “opened position” assumed by the seat-shutter assembly 5, 7 of the hydraulic fluid spray device 4.

On the other hand, as soon as the seat-shutter assembly 5, 7 of the hydraulic fluid spray device 4 is “closed”, the pressure inside the internal pipe 22 increases back to a point at which the shutter 31 (membrane type) is deformed in order to clog the seat 32.

Such an embodiment is sufficient to achieve the two main objectives of the invention in question, after all:
The “remote actuation” of the seat-shutter assembly 32, 31 of the primary valve 1 by means of the “local actuation” of the seat-shutter assembly 5, 7 of the hydraulic fluid spray device 4 ensures that the valve 1 stays “closed” while the hydraulic fluid spray 4 is “closed” and, that valve 1 stays “opened” while the hydraulic fluid spray 4 is “opened”.
While the primary valve 1 and the hydraulic fluid spray 4 are closed, the pressure of the hydraulic network is confined within the internal pipe 22 of the dual pipe, which, for being more atrophied, withstands higher pressures with lower risks of disruption. This means that the chances of rupture of the external pipe 21 of the dual pipe are minimal, and consequently the problems of leakage and/or disruption, as discussed above, are mitigated.

It is important to note that the above description has the sole purpose of describing in an exemplary manner the particular embodiment of the utility model in question. It is therefore clear that modifications, variations and constructive combinations of the elements performing the same function in substantially the same manner to achieve the same results, remain within the scope of protection delimited by the appended claims.

1. The hydraulic flow control system, comprising:
at least one primary valve provided with at least one fluid inlet path, at least one fluid outlet path, and at least one seat-shutter assembly arranged between the at least one fluid inlet and at least one fluid outlet;
at least one hydraulic fluid spray device provided with at least one fluid inlet path, at least one fluid outlet path, at least one seat-shutter assembly arranged between the at least one fluid inlet path and the at least one fluid outlet path, and at least one operating means;
said hydraulic flow control system being especially characterized by the fact that the fluid outlet path of the primary valve and the fluid inlet path of the hydraulic fluid spray device are fluidly connected by means of at least one dual pipe formed by an external pipe and an internal pipe ;
the changing of the operating state of the seat-shutter assembly of the hydraulic fluid spray device is carried out directly by means of the handling of the operating means of the hydraulic fluid spray device;
the changing in the operating state of the seat-shutter assembly of the primary valve is indirectly performed by means of the handling of the operation means of the hydraulic fluid spray device.

2. The system, according to claim 1, characterized by the fact that the seat-shutter assembly of the primary valve is sensitive to the existing pressure differential between the hydraulic pressure of the fluid inlet path of the primary valve and to the pressure of the internal pipe of the dual pipe, which fluidly connects the fluid outlet path of the primary valve and the fluid inlet path of the hydraulic fluid spray device.

3. The system, according to claim 2, characterized by the fact that the seat-shutter assembly of the primary valve assumes an “opened position” from the decrease in the pressure of the internal pipe of the dual pipe, which fluidly connects the fluid outlet path of the primary valve and the fluid inlet path of the hydraulic fluid spray device.

4. The system, according to claim 3, characterized by the fact that the pressure of the internal pipe of the dual pipe, which fluidly connects the fluid outlet path of the primary valve and the fluid inlet path of the hydraulic fluid spray device is decreased as a function of the “opened position” assumed by the seat-shutter assembly of the hydraulic fluid spray device.

5. The system, according to claim 4, characterized by the fact that the seat-shutter assembly of the hydraulic fluid spray device assumes an “opened position” from the handling of the operating means.

6. The primary valve for hydraulic flow control system, comprising:
at least one fluid inlet path;
at least one fluid outlet path;
at least one seat-shutter assembly arranged between at least one fluid inlet path and the at least one fluid outlet path; the shutter of the seat-shutter assembly comprising a flexible membrane; the seat of the seat-shutter assembly comprising a rigid tubular body;
the primary valve for the hydraulic flow control system being especially characterized by the fact that its fluid outlet path is especially adapted to receive a dual pipe formed by an external pipe and an internal pipe;
the external pipe of the dual pipe is connected to the seat of the seat-shutter assembly; and
the internal pipe of the dual pipe is associated with the shutter of the seat-shutter assembly;
wherein in a “closed position”, two pressurized chambers are defined;
the pressurized chamber is equalized to the hydraulic pressure of the fluid inlet path;
the pressurized chamber is equalized to the hydraulic pressure of the internal pipe of the dual pipe; and
the inside of the external pipe of the dual pipe is isolated from the pressurized chambers.

7. The valve, according to claim 6, characterized by the fact that, in an “opened position”, a single pressurized chamber is defined;
the external pipe and the internal pipe of the dual pipe are equalized to the hydraulic pressure of the pressurized chamber.

8. The hygienic shower head for hydraulic flow control system, comprising:
at least one fluid inlet path;
at least one fluid outlet path;
at least one seat-shutter assembly arranged between at least one fluid inlet path and at least one fluid outlet path, and at least one operating means;
the hygienic shower head for hydraulic flow control system being especially characterized by the fact that its fluid inlet path is especially adapted to receive a dual tube formed by an external pipe and an internal pipe;
the external pipe of the dual pipe is connected to the seat of the seat-shutter assembly; and
the internal pipe of the dual pipe is associated to the shutter of the seat-shutter assembly;
wherein in a “closed position”, two pressurized chambers are defined;
the pressurized chamber is equalized to the hydraulic pressure of the fluid inlet path;
the pressurized chamber is equalized to the hydraulic pressure of the internal pipe of the dual pipe;
and the inside of the external pipe of the dual pipe is isolated from the pressurized chamber.

9. The hygienic shower head, according to claim 8, characterized by the fact that it further comprises an externally arranged operating means.

10. The hygienic shower head, according to claim 9, characterized by the fact that said operating means comprises a handle capable of angular movement.

11. The hygienic shower head, according to claim 10, characterized by the fact that the angularly movable handle cooperates with a pivot axis arranged within the body of said hygienic shower head.

12. The hygienic shower head, according to claim 11, characterized by the fact that the shutter of the seat-shutter assembly is physically cooperative with a pivot axis arranged inside the body of said hygienic shower head.

13. The hygienic shower head, according to claim 11, characterized by the fact that the angular movement of the operating means changes the axial alignment between the seat and the shutter of the seat-shutter assembly.

14. (canceled)
